(19) United States
(12) Patent Application Publication
(10) Pub. No.: US 2026/0209873 A1
(43) Pub. Date: Jul. 23, 2026

(54) Biomass Direct Reduced Iron

(71) Applicant: TECHNOLOGICAL RESOURCES PTY. LIMITED, Melbourne, Victoria (AU)

(72) Inventors: Christopher Dodds, Nottingham (GB); Andrew Rhodes Batchelor, Nottingham (GB); Samuel Kingman, Nottingham (GB); Jose Rodriguez, Nottingham (GB); Iain William Farr, Perth, Western Australia (AU)

(21) Appl. No.: 19/142,316

(22) PCT Filed: Dec. 21, 2023
(86) PCT No.: PCT/AU2023/051350

§ 371 Date: Jun. 23, 2025

(30) Foreign Application Priority Data
Dec. 23, 2022 (AU) 2022904021

(51) Int. Cl. C21B 13/10; C21B 13/12

(52) U.S. Cl. CPC C21B 13/10; C21B 13/12

(57) ABSTRACT

A method and an apparatus for producing direct reduced iron (DRI), typically continuously, from iron ore using biomass as a main source of reductant in a hearth furnace having a preheat zone, a reduction zone, and a transition zone between the preheat and the reduction zones, with the transition zone being configured for compacting iron ore/biomass material carried on the conveyor as it moves through the transition zone from the preheat zone to the reduction zone so that it presents a more compacted bed of material which is better suited to processing with microwave energy in the reduction zone.

### TECHNICAL FIELD

The present invention relates to a method and an apparatus for producing direct reduced iron (DRI) from iron ore and biomass.

The present invention relates particularly, although by no means exclusively, to a method and an apparatus for continuously producing DRI using a hearth furnace having interlinked furnace zones with biomass as a reductant and heat source and microwave energy as a supplemental energy source to facilitate further heating and reduction.

Such DRI, for example while hot, may be subsequently melted in a furnace to create hot metal, then cast as pig iron or refined further to steel in a metallurgical furnace. Alternatively, the hot DRI may be compressed between a pair of rollers with aligning pockets to form a hot briquetted iron (HBI), which can subsequently be supplied to a furnace as a cold charge.

The term “hearth furnace” describes a furnace that includes a lengthwise (whether linear or circular) extending heating chamber and a base that extends along the length of the chamber from an inlet end to a discharge end that carries material through the chamber for rapid thermal processing in the chamber.

The term “direct reduced iron” is understood herein to mean iron produced from the direct reduction of iron ore to iron by a reducing agent at temperatures below the bulk melting temperature of the solids. For the purposes of the discussion herein “direct reduced iron” (DRI) is understood to have at least 85% metallisation.

The term “metallisation” is understood herein to mean the extent of conversion of iron oxide into metallic iron during reduction of the iron oxide, as a percentage of the mass of metallic iron divided by the mass of total iron.

### BACKGROUND

Iron and steel making are historically carbon intensive processes in which the majority of the carbon used is eventually oxidised to CO₂ and discharged to the atmosphere. With the world seeking to reduce overall atmospheric CO₂ there is pressure on iron and steel makers to find means to make iron and steel without causing net emissions of greenhouse gases. In particular, there is pressure not to use coal or natural gas, which are considered non-renewable.

The majority of iron in the world is produced by the blast furnace route, which is a technology that has existed since prior to the industrial revolution. Even with technology advances, the blast furnace currently still requires around 800 kg of metallurgical coal for every tonne of iron produced and emits high levels of CO₂, roughly 1.8-2.0 tonne CO₂ per tonne of hot metal. The use of fossil fuels, in particular the requirement for coal (in the form of coke), is an essential feed material for a blast furnace to operate, and it is not possible simply to use hydrogen therein as a complete substitute.

An alternative approach to blast furnaces is the direct reduction of iron ore in a solid state by carbon monoxide and hydrogen derived from natural gas or coal. While such plants are (outside of India) minor in number compared to blast furnaces there are many processes for the direct reduction of iron ore. In India, coal based rotary kiln furnaces are used to produce DRI, also known as sponge iron (approaching 20% of world production of DRI), while elsewhere they tend to be gas-based shaft furnace processes (approaching 80% of world production of DRI). The gas-based direct reduction plants are usually part of integrated steel mini-mills, located adjacent an electric arc furnace (EAF) steel plant, but some DRI is shipped from captive direct reduction plants (usually Midrex™ or HYL™ process based plants) to remote steel mills. Because the DRI is used in electric arc furnaces, there are strict requirements on the levels of impurities in the DRI such as gangue and phosphorus which are expensive and difficult to remove in the EAF. Hence, the iron ores used to make DRI are often crushed and ground to micron particle sizes to enable removal of gangue minerals. Such fine material is difficult to handle (both transport and operationally wise). Therefore, the fine material is agglomerated using water and/or binder to produce closely sized ‘green’ balls which are, once dried, then fed into furnaces where the ‘green’ balls are fired into hard pellets (a process known as induration), before eventually being supplied to direct reduction plants as feed material (or sometimes to blast furnaces as a high quality iron ore feed material to help dilute the gangue of the lump or sinter iron ore that a blast furnace uses). The ‘green’ balls that form the pellets have a typical compressive strength of around 10 N when wet, and 50 N when dried. As pellets (after induration), they have a compressive strength of around 2000 N.

One proposal for an alternative to all of the above is the production of DRI using hydrogen from iron ores (in the form of an indurated pellet feed) followed by smelting in an EAF to produce steel. For this route to be carbon neutral it requires conversion of renewable (green) energy into hydrogen (particularly in periods when wind/solar power cost is low), with subsequent production of DRI using the hydrogen. This route has strong support in Europe and has the potential to become a significant part of the global solution (1). However, there are limitations, as follows.
1. The amount of electricity needed is high (estimated at 3500-4500 kWh/t to the liquid steel stage) and green power costs need to be low (or alternatively a high carbon tax needs to in place) for it to become cost-effective against coal and natural gas-based processes.
2. Hydrogen consumption requirements for the production of DRI are likely to be steady, whilst the generation of the actual hydrogen is likely to be periodic in line with the availability of renewable energy, like wind and solar. This calls for a buffering approach to balance supply and demand. Storage and delivery of large amounts of hydrogen however is a technical challenge. Underground salt caverns and exhausted natural gas reservoirs appear to show good potential. However, not all geographical locations may be amenable to this type of hydrogen storage. Moreover, suitable storage locations may not be close to DRI facilities for existing EAF steel mills and/or integrated steelmaking facilities, resulting in supply challenges.
3. Only low-gangue ore types (or those able to readily be upgraded to remove gangue) can be used with the DRI/EAF combination. The EAF will penalise high gangue ore types strongly, rendering them essentially non-competitive. This implies much of the ore currently used in blast furnaces could become sub-economic for such a process route.

It is known that sustainable biomass could be a complementary part of the solution, acting as a substitute for fossil fuels. Burning of either fossil fuels or biomass will release CO₂ when used, however when fast growing plants are the source of the biomass, they are largely a carbon-neutral energy source (since through photosynthesis around the same amount of CO₂ is taken up when the plants are regrown).

To date there is no large-scale commercial ironmaking process that uses biomass directly, including for the DRI production route. Previous attempts to insert some biomass into processes originally designed for coal (e.g., blast furnaces and coke ovens) are marginal at best, typically relying on a pre-charring step for the biomass and usually quite disappointing in terms of overall CO₂ impact. This is largely because the nature of biomass is vastly different to that of coal. To use biomass successfully it is necessary to re-design the process around the fundamental nature of biomass.

Biomass can take many forms and avoiding competition with food production is key for biomass selection. Examples of biomass that might meet the selection criteria include elephant grass, sugar cane bagasse, forestry by-products, excess straw, azolla and seaweed/macroalgae. Such biomass availability varies considerably from one geographic location to another—and will most likely be a significant factor in determining the size and location of future biomass-based iron plants given the volume of material required and the economic challenges in transporting such material long distances.

Biomass, such as wood chips, has been shown in lab-scale studies (2) to be able to reduce iron ore to solid iron by the intermingling thereof with iron ore and placing in a furnace that heats the ore up to over 800° C. within a controlled atmosphere that prevents re-oxidation of the reduced material. While intermingling assists with the efficacy of the reduction process, on an industrial scale as a continuous process it potentially creates challenges, where gas flow created by convection heating as part of the reduction process picks up fine particles of char, leading to massive gas processing/char recycling challenges, or a lot of carbon being wasted through the need to clean up the off-gases from the process, before discharge to the atmosphere.

Another example (described from laboratory phase experiments) is disclosed in Australian patent AU 2007227635 in the name of Michigan Technological University. The patent discloses the use of briquettes (for example, in the shape of coherent spherical balls) produced by mixing iron ore concentrate comprising magnetite (Fe₃O₄), wood chips that have passed through a 4.75 mm sieve, a small amount of flour, and slight moistening (to achieve agglomeration). The patent discloses that the composites are dried at 105° C. (to provide strength and rigidity) in handling. The composites are then placed in a furnace (that is electrically heated) at temperatures in excess of 1375° C. to undertake the reduction of the iron ore. The patent discloses that preferably fine iron ore particles should be used and that while ‘particles as large as 0.25 inch in diameter’ (i.e., the typical top size of iron ore fines, being 6.35 mm) ‘or larger could be used, processing times would be unnecessarily long, and particles would not lend themselves to being formed into a coherent mass’.

The application of electromagnetic energy, such as microwave (MW) energy and radio frequency (RF) energy in iron ore reduction processes, whether as simply a form of heating energy or as a means to enhance reaction rates or provide additional heating at crucial times in the reaction process, to produce DRI has also been considered. One of the first laboratory attempts known to the applicant is described in U.S. Pat. No. 4,906,290 assigned to Wollongong Uniadvice Limited. The patent discloses that briquettes containing a mixture of iron ore fines, coal and burnt lime were subjected to microwaves until they glowed red and were then placed in a crucible where they were smelted to produce a molten iron containing 3.8% carbon. While no examination of the microwave product from the microwaving is disclosed in the patent, the applicant suspects that DRI was produced.

Another attempt in a laboratory where both MW energy and/or RF energy was applied to iron ore reduction is set out in US patent publication US 2009/0324440 assigned to Anglo Operations Limited. Although perhaps more focussed on ways to process titaniferous (i.e., ilmenite) type material, which would first be pre-oxidised to enhance reactivity (by the burning of any available fuel, including biomass, in an oxygen rich environment to facilitate such oxidation), it does disclose the reduction of hematite type iron ore in a fluidised bed reactor under atmospheres of solely H₂ (at temperatures between 400° C. and 600° C.) or CO (at temperatures between 600° C. and 800° C.) with or without the presence of MW energy or RF energy. The tests with such energy showed enhanced reaction rates, without any significant additional heating from the application of such energy. The tests appear to be confined to domestic MW work.

Another attempt (also laboratory-based) to enhance reaction rates or provide additional heating at crucial times in the reaction process, to produce DRI is described in International application PCT/AU2017/051163 in the name of the applicant. The application describes an invention of a process and an apparatus for direct reduction of iron ore in a solid state wherein briquettes of iron ore fragments and biomass are passed through a preheating chamber where they reach at least 400° C. before entering a heating/reduction chamber that is under anoxic conditions with biomass as a reductant and with electromagnetic energy as a source of energy.

Thus, various laboratory-scale studies have shown that iron ores mixed with biomass and heated in a small furnace can produce DRI in a manner that appears (superficially) somewhat better than that expected from first principles. Likewise, the use of electromagnetic energy in such iron ore reduction processes has been shown to be advantageous.

The technical challenge remains of how to perform this efficiently at large scale, particularly where electromagnetic compatibility (EMC) requirements impose stringent limits on any emissions outside the internationally agreed and recognised bands for the application of MW energy and RF energy. These limits are much lower than those imposed by health and safety and are typically equivalent to μWs of power at any frequency outside the allowed bands.

One proposal for a reduction process for direct reduction of iron ore in a solid state under anoxic conditions with biomass as a reductant and with electromagnetic energy as a source of energy that may operate at scale is described in International application PCT/AU2021/051398 in the name of the applicant. The application describes an invention of a process and an apparatus for direct reduction of iron ore in a solid state under anoxic conditions with biomass as a reductant and with electromagnetic energy as a source of energy where gases arising from reduction of the ore from that point (a reduction zone) flow into an oxygen-available combustion zone where the iron ore may be initially heated from such combustion (a preheat zone), while still maintaining anoxic conditions in the reduction zone. This approach is colloquially described as ‘countercurrent’ as briquettes (of a composite of iron ore fragments and biomass) travel in one direction and the off-gases from reduction therein travels in the opposite direction. The disclosure in the application is incorporated herein by cross-reference.

A further attempt to set out how such a reduction process for direct reduction of iron ore in a solid state under anoxic conditions with biomass as a reductant and with electromagnetic energy as a source of energy might operate at scale is described in Australian patent application AU2022900604 in the name of the applicant. The application describes an invention for producing direct reduced iron (DRI) in a hearth furnace having a preheat zone and a reduction zone, where a conveyor carrying material at least initially is in the form of briquettes of iron ore and biomass successively passes through the preheat zone and the reduction zone in a direction from an inlet to an outlet, with reduction gases including combustible gases produced by heating material and by reduction of iron ore flowing in an opposite direction to that of the conveyor, i.e. towards the preheat zone, where combustible gases in the reduction gases are combusted via air or oxygen-enriched air fed burners while maintaining an anoxic atmosphere in the reduction zone, with microwave energy to facilitate heating and reduction of iron ore in the anoxic atmosphere of the reduction zone being delivered directly onto material on the conveyor via a plurality of microwave horns arranged in a plurality of rows extending across a width of and along a section of a length of the reduction zone with the outlets thereof being spaced above but in close proximity to material on the conveyor, and with the reduction zone including a lower sub zone and an upper sub zone separated by an interface above the openings of the horns, that is configured so that (a) microwave energy is at least substantially prevented from passing through the interface to the upper sub zone, (b) reduction gases produced in the lower sub zone from reduction of iron ore can flow through the interface into the upper sub zone. The disclosure in the application is incorporated herein by cross-reference.

The applicant has carried out further development work into the invention described in the above applications of the applicant to better establish how to perform the invention at scale in an efficient manner.

It is understood that the above description is not to be taken as an admission of the common general knowledge in Australia or elsewhere.

It is also understood that the number of skilled persons in the field of the invention in Australia and elsewhere is very small.

### SUMMARY OF THE DISCLOSURE

The present invention is based on a realisation that consideration of a number of potentially conflicting demands is required when seeking to have an effective and efficient method for producing direct reduced iron (DRI) from iron ore, using biomass (as a source of reductant and as a heating source of the iron ore) and electromagnetic energy in the form of microwave energy (as a further heating source) in a hearth furnace in which there is a conveyor transporting a bed of iron-containing material, such as iron ore, typically at least initially in the form of briquettes of iron ore and biomass, from an inlet (briquette feed) end to an outlet (DRI discharge) end, where combustible gases arising from heating biomass and reduction of iron ore are combusted by air or oxygen-enriched air fed burners in one zone of the furnace (the “preheat zone”) and where microwave energy is supplied within an anoxic atmosphere zone of the furnace (the “reduction zone”), with gases generated in the reduction zone flowing into the preheat zone, counter to the direction of movement of iron-containing material.

One conflicting demand is the impact of different heating mechanisms for a preheat zone and a reduction zone due to the different forms of heating in these zones.

In the preheat zone, heating supplied briquettes of iron ore and biomass is in the first instance primarily via radiation heating, where the radiation arises from the combustion of combustible gases by air or oxygen-enriched air in a top space of the preheat zone. Heat from the furnace atmosphere, through convection from such hot gases circulating in the top space contacting briquettes, will also heat briquettes. Heat from both these mechanisms is then transferred by conduction through briquettes. Heat from a base of a conveyor on which the briquettes sit, to the extent that it is hotter than the briquettes, will also play a part in heat transfer to briquettes.

In relative terms, this transfer of heat in the preheat zone compared to heating by microwaves (discussed later) in the reduction zone is a slow process. On a micro level of individual briquettes, all the heat energy required must essentially pass through the briquettes surface, and the rate of heat flow within briquettes is limited by surface temperature and thermal diffusivity of the briquettes. On a macro level of a bed of briquettes, this is further affected by, among other things, the height of the bed, the spacing between the briquettes (i.e., how much radiation is able to pass to briquettes below the top briquettes through penetration into the voids), and the time in the preheat zone (a function of the length thereof and the speed of conveyance).

In the reduction zone, heating is in the first instance through the creation of an alternating electromagnetic field, with heat arising from exciting dielectric material and other potential complex reactions around conductivity and electron mobility. That heat is then in part transferred by conduction through bulk material in the reduction zone and through convection of hot reduction gases as they escape the material.

In relative terms, compared to heat transfer in the preheat zone discussed above, this transfer of heat energy in the reduction zone is a fast process as heat arises internally within the material, although it is affected by, among other things, the height of the bed of material, the frequency and intensity of the microwaves, the dielectric properties of the bed, and the time in the reduction zone (a function of the length thereof and the speed of conveyance; noting speed is usually fixed by the speed of travel set for the preheat zone).

Another factor is that, as far as practical, microwave energy within the reduction zone should be delivered towards a top surface of the conveyor in a well-defined energy pattern with a view to providing uniform energy absorption across and along the bed of iron-containing material such as iron ore. It is known that the shape of a dielectric material impacts the surrounding electric field distribution. In this application, a bed of particles is being presented to the electromagnetic field. Ideally, the bed is as uniform as possible so that localised field concentrations due to the size, shape, location and distribution of particles do not result in a reduction in product quality and process reliability due to excessive heating in these areas resulting in arcing/dielectric breakdown.

Thus, there is a conflict between the physical requirements for iron ore/biomass material for the above heating mechanisms in the two zones. For example, while large voids in a mass of an iron ore/biomass material will assist with heating material in the preheat zone, they can be detrimental to heating material in the reduction zone. Further, while the effective penetration of microwaves into a bed of material in the reduction zone increases with compaction of material in the bed across the height of the bed, this is not necessarily a positive for heating material in the preheat zone.

A further factor is to keep microwaves contained safety within the furnace. While the use of an array of microwave horns in the reduction zone in close proximity to a moving bed of iron-containing material ensures that microwaves are mostly absorbed by the bed, the larger the area of the furnace over which they are allowed to spread the more difficult it is to ensure they remain inside the furnace i.e., there are more potential leakage points.

The applicant has realised that the above conflicting demands can at least in part be accommodated by providing a transition zone between the preheat zone and the reduction zone, with the transition zone having particular features therein that allow the physical requirements for iron ore/biomass material on the bed to be adjusted to meet the conflicting heating demands in the preheat zone and the reduction zone. Specifically, the transition zone is configured for compacting iron ore/biomass material.

The invention provides a method and apparatus for producing direct reduced iron (DRI), typically continuously, from iron ore using biomass as a main source of reductant in a hearth furnace having a preheat zone, a reduction zone, and a transition zone between the preheat and the reduction zones, with the transition zone being configured for compacting iron ore/biomass material carried on the conveyor as it moves through the transition zone from the preheat zone to the reduction zone so that it presents a more compacted bed of material which is better suited to processing with microwave energy in the reduction zone.

The method includes moving a conveyor carrying an iron ore/biomass material, typically at least initially being in the form of briquettes of iron ore and biomass, successively through the preheat zone, the transition zone, and the reduction zone in a direction from an inlet to an outlet and heating and reducing iron ore and discharging DRI from the outlet, allowing reduction gases including combustible gases produced by heating material and by reduction of iron ore to flow in an opposite direction to the direction of movement of the conveyor, i.e., towards the preheat zone, combusting combustible gases in the reduction gases via air or oxygen-enriched air fed burners in the preheat zone, while maintaining an anoxic atmosphere in the reduction zone and supplying microwave energy therein to facilitate reduction of iron in the reduction zone, and compacting material carried on the conveyor and forming a more compacted bed of material as material moves through the transition zone and before material reaches the reduction zone.

Typically the more compacted material is more suited to processing with microwave energy in the reduction zone.

The term ‘compacting’ means that, after compaction, the material is more homogenised in terms of the density of material and voids across the height of the material as a consequence of compaction than was the case in the preheat zone. The material in the compacted state may not be in the initial feed briquette shape.

The transition zone need not be the same size and shape as either the preheat zone or the reduction zone.

The transition zone may be any suitable size and shape.

The material on the conveyor in the transition zone may absorb microwave energy, resulting in heating the material.

The method may include ‘compacting’ the material on the conveyor by a roller (or a series of successive rollers), such as a driven roller, such as an internally-cooled driven roller, contacting an upper surface of the material in the transition zone and thereby compacting material as material passes through a gap between the roller and the conveyor.

The method may include selecting a rotational speed of the roller such that a velocity of an outer surface of the roller in the direction of movement of the conveyor is substantially the same as a velocity of the conveyor in the direction of movement of the conveyor.

The rotational speed of the roller may be varied as required to suit operational circumstances.

The method may include compacting material as it moves through the transition zone so that a cross-sectional area of the material is reduced by reducing a height thereof. In other words, in this embodiment, compaction is a result of bed height reduction.

The method may include applying a constant downward pressure on the material via the roller. The method may include applying a variable downward pressure on the material via the roller.

The roller may be located anywhere in the transition zone.

The roller may be located towards the preheat zone end of the transition zone.

The roller may be located sufficiently within the transition zone so that it is not substantially exposed to direct heating from combustion of combustible gases via air or oxygen-enriched air fed burners in the preheat zone.

The transition zone may comprise a microwave choke that is configured to at least substantially prevent microwave energy from passing from the reduction zone to the preheat zone.

Any appropriate microwave choke may be selected for the transition zone.

The microwave choke may include an elongated metal section, such as a channel-shaped section, positioned in close proximity above and to the sides of the material on the conveyor.

The microwave choke may include a series of chambers, for example generally rectangular chambers, extending above and across a path of the conveyor as part of the elongated metal section residing in close proximity above and to the sides of the material on the conveyor. The series of chambers may be described as a ‘corrugated’ baffle.

Microwave energy may be delivered directly into the material on the conveyor via any suitable options.

For example, microwave energy may be delivered directly into the material on the conveyor via a plurality of microwave horns having microwave outlets in the reduction zone.

The horns may be arranged in a plurality of rows extending across a width of and along a section of a length of the reduction zone.

The microwave outlets may be spaced above but in close proximity to the material on the conveyor.

The rows of horns may be spaced apart along the length of the section of the length of the reduction zone so that there are gaps between successive rows.

The horns in at least some of the rows may be spaced apart so that there are gaps between the horns.

In combination therewith, when the horns are spaced apart in the rows and/or between the rows, there may be a microwave energy barrier in gaps between the horns that is configured to allow reduction gases to pass therethrough and to prevent microwave energy passing therethrough so that microwaves are substantially confined to a lower sub zone of the reduction zone.

The microwave energy barrier may be a perforated plate that forms a skirt that fills gaps between the horns thereby creating two distinct zones, a lower sub zone where there is microwaves and reaction gases and an upper zone where there is reaction gases without any substantial microwave radiation that has its origins from exiting the horns.

The use of the term “reaction gases” does not exclude other gases being present, for example nitrogen, which may for example have its source from injection into the microwave delivery system.

The horns of at least some of the rows may be offset laterally relative to the horns of at least some of the other rows—i.e. laterally relative to the direction of movement of material through the reduction zone.

More particularly the horns of each row may be offset with respect to the horns of successive rows. While not limited thereto, such offset may be effected though, all or in part 90 degree rotation of horns.

The method may include supplying microwave energy to each horn so as to deliver microwave energy to form a well-defined field pattern, such as a hotspot on material on the conveyor.

The method may include supplying microwave energy to the plurality of rows of horns to create a uniform, typically highly uniform, regular heating pattern for material on the conveyor in the reduction zone.

The average difference in height of each horn above the height of material on the conveyor may be selected to be sufficiently small so that there is a highly resonant and well-defined field pattern which maximises absorption and homogeneity across a defined area and minimises cross coupling of microwave energy.

The horns may be any suitable design, such as pyramidal or conical, and any suitable length.

In one embodiment, focussed on efficiency of microwave delivery to create a uniform, typically highly uniform, regular heating pattern, the horns are pyramidal horns.

The pyramidal horns may be sectorial horns, each with one pair of opposing sides being flared and the other pair of opposing sides being parallel.

Typically, the sectorial horns produce fan-shaped beams, which are narrow in the plane of the flared sides, but wider in the plane of the narrow sides.

The flaring may be in the E-plane (electric field) or H-plane (magnetic field) direction so that the microwave outlet is a rectangular-shaped opening.

The sectoral horns in each row may be placed across the conveyor so that the shorter sides of rectangular microwave outlets of the sectoral horns are parallel with the direction of moment of the conveyor within the reduction zone.

Without limiting the design combinations, the microwave energy barrier may be in the form of perforated metal elements (described below as skirts) that are connected to the horns close to the microwave outlets of the horns (with the arrangement being described below as skirted horns) to, in effect, form a single continuous perforated interface at this height of the reduction zone to substantially confine the microwaves to the lower sub zone of the reduction zone.

For the avoidance of doubt, the use of such skirted horns leads potentially to the creation of at least two distinct reaction gas paths, one above and the other below the skirt, that follow different paths. If the lower gas path exists (beyond leakage due to unavoidable gaps around the driven roller in the transition zone) the gas flow must be sufficiently unrestrained so that reaction gases that flow from the lower sub zone through the elongated metal section that forms the microwave choke do not lead to excessive gas velocity along that path that significantly entrains material passing therethrough.

In any given scenario, the selection of the size and shape of perforations for a microwave barrier between the subzones will be a function of factors including microwave energy wavelength, perforation shape and characteristics of the material of the skirt. The typical shielding effectiveness (SE) of a metal perforated metal plate depends on the wavelength, perforation size (such as hole diameter) and plate thickness. For example, to ensure a negligible leakage (SE>60 dB, ~99.9999% containment) through a metal plate at 915 MHz, plates with a thickness of 3 mm, 5 mm, and 10 mm, would require holes (where holes are selected for the perforations) smaller than 3 mm, 4.5 mm, and 8 mm respectively. If wider holes are required, then tubes could be used in which case for example a 100 mm diameter tube would need to be 220 mm long in order to provide the same level of confinement.

The term “heath furnace” is understood herein to mean a furnace that is circular or linear in nature and of a generally horizontal disposition that is refractory lined, through which some form of conveyor passes, with the conveyor eventually returning to its conceptual starting point and upon which, while passing through the furnace, briquettes can reside, and in which gases from the heating of such briquettes and reduction of the iron ore within are substantially contained before passing from the furnace for eventual discharge as flue gases.

The use of the term “discharge as flue gases” does not exclude further use(s) and/or combustion of any combustible residual gases so that residual heat energy from the gases can be utilized or recovered before the gases are finally discharged to the atmosphere.

The term “conveyor” is understood herein to mean any apparatus that forms a moving surface upon which briquettes may reside in essentially a static position (on such surface) while passing through the furnace and being reduced, but is not to be limited to any particular form of moving base, the only requirement being that it passes in a circuit which has each part of the base eventually returning to its conceptual starting point (with the same orientation).

Without in any way limiting, and as examples only, such base may in the case of a linear heath furnace be:
(a) a plurality of individual trays or plates (whether of metal, refractory material or a blend of both);
(b) a linked segmented high temperature resistant metal belt, or
(c) a single unbroken metal belt formed from joining up a strip(s) or elongated sheet(s) of suitable high temperature resistance metal that while passing through the furnace (or a significant portion thereof) form a contiguous elongated generally linear base on which briquettes can reside.

The term “anoxic” is understood herein to mean substantially or totally deficient in oxygen.

The term “briquette”, as originally fed into the hearth furnace, is understood herein as a broad term that means a composite of iron ore fragments and biomass that has formed as a result of the iron ore fragments and biomass being brought into close contact through compaction, or alternatively through mixing and binding, of the iron ore and biomass together. Those skilled in the art would typically describe the latter (particularly when in a spherical form) as pellets. While the inventors believe “green” pellets have some inherent challenges, not least being they usually need to be carefully dried first (thereby avoiding any sudden steam evolution) and any chosen binder used cannot be one where massive instantaneous devolatilization occurs during heating-both events potentially leading to structural failure of the pellet; pellets are not excluded, but the term briquette does not include indurated pellets, as a feed material according to the method, as such pellets basically get their increased compressive strength by oxidation of the iron ore fragments at temperature back to a higher state of oxidation and through sintering with at least some cross bonding between such fragments. As such they cannot contain biomass (at least not in a uncarbonized form, i.e., any residual carbon remaining could only be there simply as a function of oxidation reactions not being provided with sufficient time to reach equilibrium).

It will be understood that the composition, size, shape and/or integrity of briquettes will vary as they are processed through the hearth furnace to eventually exit as DRI. The briquettes may lose structural integrity and not be in a form that resembles the feed briquettes. The use of the term ‘briquette’ when describing the passage of material through various zones of the furnace is not intended to be self-limiting to what was originally fed into the hearth furnace but is used merely for descriptive convenience.

The term “fragment” is understood herein to mean any suitable size piece of iron ore (as passed through an appropriately screen mesh of 6.35 mm spacing or below) and as used herein may be understood by some persons skilled in the art to be better described as “particles” and/or “fines”. The intention herein is that such terms be used as synonyms. The iron ore may be any suitable type such as magnetite, hematite and/or goethite. However, it does not preclude other iron rich ores from which iron may be extracted such as limonitic laterites, titaniferous magnetite and vanadiferous magnetite due to the local unavailability of the more usual forms of iron ore from which iron is traditionally extracted.

The term “biomass” is understood herein to mean living or recently living organic matter. Specific biomass products for a composite of iron ore fragments and biomass include, by way of example, forestry products and their by-products (in the form of woodchips, sawdust and residues therefrom), agricultural products and their by-products (like sorghum, hay, straw and sugar cane bagasse), agricultural residues (like almond hull and nut shells), purpose grown energy crops such as Miscanthus Giganteus and switchgrass, macro and micro algae produced in an aquatic environment, as well as recovered municipal wood and paper wastes.

To achieve the desired removal of the majority of volatiles from the biomass within heated briquettes prior to briquettes leaving the preheat zone, the finish preheat temperature for the briquettes (as a collective as they leave the preheat zone, i.e., bulk temperature) may be in a range of 600 to 800° C., and more typically at least 700° C. to 800° C. Because of the nature of a bed of briquettes, the temperature throughout the bed (at least in the preheat zone) will not be uniform and will definitely vary through the bed and may also vary across the bed.

Volatiles is usually understood in respect to carbonaceous material to mean gases, other than those arising from water (whether bound or free) being initially driven off, that are formed or released by heating of the carbonaceous material to cause breakdown of organic components therein to gases or liquids.

Unlike the position with coal, the inventors are not aware of an industry standard for measuring volatiles in biomass. For coal, volatiles (volatile matter) is measured as a weight percentage of gas (emissions) from the coal sample that is released during heating to, typically, 950° C. in an oxygen free environment, except for moisture (which will evaporate as water vapour) at a determined standardization temperature. The inventors believe that it is desirable generally for low-boiling-point organic compounds that will condense into oils on cooling to not be present in the residual biomass that passes into the reduction zone, where such compounds have the potential to interfere and/or interact with the microwave system.

Accordingly, the term “volatiles” is understood herein to mean only low-boiling-point organic compounds that are driven off at temperatures below 600° C. upon heating in an oxygen free environment.

Typically, the method includes supplying briquettes at ambient temperature to the preheat zone of the furnace and progressively heating briquettes to a finish preheat temperature as briquettes are transported through the preheat zone on the conveyor.

The method may include controlling the method so that at least 90%, typically at least 95%, of volatiles in biomass in the briquettes is released as a gas in the preheat zone.

The control options for achieving volatilisation mentioned in the preceding paragraph include controlling, by way of example, any one or more than one of the temperature profile in the furnace, the residence time of briquettes in the preheat zone, the length of the preheat zone, the travelling speed of the conveyor, the briquette loading on the conveyor, and the amount of biomass in the briquettes, noting that a number of the factors are inter-related.

By way of example, the travelling speed i.e., velocity, of the conveyor may be controlled so as to give briquettes sufficient time in the preheat zone for at least 90%, typically at least 95%, of the volatiles to be released from biomass in briquettes.

The travelling speed may also be controlled so that heating briquettes in the reduction zone using microwave energy alone increases the temperature of briquettes by at least a further 150° C., and preferably at least 250° C.

It is noted that travelling speed is not the only factor relevant to achieving the at least 150° C. temperature increase of briquettes in the reduction zone. Other factors include controlling, by way of example, any one or more than one of the residence time of briquettes in the reduction zone, the length of the reduction zone, the briquette loading on the conveyor, the type and power of the microwave energy, noting that a number of the factors are inter-related.

The briquettes, as originally fed into the hearth furnace, may be any suitable size and shape.

By way of example, the briquettes may have a volume of less than 25 cm³ and greater than 2 cm³. Typically, the briquettes may have a volume of 3-20 cm³.

By way of example, the briquettes may have a major dimension of 1-10 cm, typically 2-6 cm and more typically 2-4 cm.

By way of example, the briquettes may be generally cuboid, i.e., box-shaped, with six sides and all angles between sides being right angles. By way of example, the briquettes may be “pillow-shaped” briquettes. By way of further example, the briquettes may be “ice hockey puck-shaped” briquettes.

The briquettes, as originally fed into the hearth furnace, may include any suitable relative amounts of iron ore and biomass. The briquettes may include 20-45% by weight on a wet (as-charged) basis, typically 30-45% by weight on a wet (as-charged) basis, of biomass. When choosing to use compacted briquettes ideally the biomass chosen has a significant lignocellulosic component within.

In any given situation, the preferred proportions of the iron ore fragments and biomass will depend on a range of factors, including but not limited to the type ore (e.g. hematite, goethite or magnetite) and their particular characteristics (such as fragment size and mineralogy), the type and characteristics of the biomass, the operating process constraints, and materials handling considerations.

The DRI on exiting the reduction zone may be at a temperature of at least 900° C., typically at least 1000° C., from the further heating by microwave energy.

Preferably, the DRI on exiting the reduction zone has a temperature in a range of 1000 to 1050° C.

The use of the term ‘reduction zone’ does not preclude iron ore reduction occurring outside that zone. Likewise, the use the use of the term ‘preheat zone’ does not of itself preclude some reduction of iron ore actually occurring therein.

The method may include generating a higher pressure of gases in the reduction zone compared to gas pressure in the preheat zone and thereby causing gases generated in the reduction zone to flow counter-current to the direction of movement of briquettes on the conveyor through the furnace.

The method may include creating higher pressure in the reduction zone by means of a gas flow “choke” between the reduction zone and the preheat zone of the furnace.

The gas flow “choke” in the reduction zone may be configured so as to increase the flow rate of gases generated from the reduction zone to the preheat zone by a factor of 2-3 compared to what the flow rate would have been without the gas flow “choke” in order to ensure that there is no substantial gas flow from the preheat zone to the reduction zone of the furnace.

The microwave energy may have any suitable microwave frequency, but the current industrial frequencies of around 2450 MHz, 922 MHz, 915 MHz, 896 MHz and 433 MHz are of most interest. For example, in Australia and South Africa 922 MHz is the allocated frequency. In USA and Europe, 915 MHz is the allocated frequency. In UK, 896 MHz is the allocated frequency. A key requirement however is the furnace be designed so that the energy is contained within the furnace.

As noted above, the briquette heating in the preheat zone may include generating heat by burning combustible gases generated in the furnace via the plurality of air or oxygen enriched air fed top space burners, typically preheated air or oxygen enriched air fed top space burners, within the preheat zone. Typically, that step includes combusting at least 90% by volume, more typically at least 95%, of combustible gases generated in the furnace.

The burners may be either (i) spaced along the top of the oven chamber or (ii) aligned more or less horizontally along the long axis to assist in ensuring a generally uniform heating pattern along the length of the preheat zone and to achieve direct radiant heat transfer from the top of the chamber.

The amount of preheated air or oxygen enriched air fed to each burner may be adjusted to compensate for established variations in fuel gas flow across and along the chamber.

In use, combustible gases in the hot gas flowing into the preheat zone from the reduction zone combust as the gases passes each of the plurality of air or oxygen enriched air fed top space burners.

The combustion profile, i.e., the profile of post-combustion of combustible gas along the length of the preheat zone, may be 35-45% at a hot end of the preheat zone, i.e., at the end adjacent the reduction zone, increasing to 90-95% at a cold end of the preheat zone, i.e., at the end adjacent the feed zone. The combustion profile may be any suitable profile.

Post combustion (PC) is defined herein as:

$$PC \% = 100 \times ( {CO}_{2} + {H}_{2} O ) / ( CO + {CO}_{2} + {H}_{2} + {H}_{2} O ) ,$$

where the symbol for each species (CO, CO₂ etc.) represents the molar concentration (or partial pressure) of that particular species in the gas phase.

In simple terms, PC is a measure of the combustion of combustible gas, with zero indicating no combustion and 100% indicating fully combusted.

It follows from the preceding paragraphs that the above combustion profile maintains the preheat zone top space in a bulk reducing condition along the length of the preheat zone, with feed oxygen being consumed rapidly in the vicinity of each burner (in a small localised region).

The method may include discharging gas produced in the furnace by heating and/or combustion within the furnace as a flue gas through a flue gas outlet in the feed zone.

The method may include processing the flue gas in a flue gas system before discharging the processed flue gas to the atmosphere.

The method may include recovering heat from the flue gas and using the heat for preheating air to the burners in the preheat zone.

By way of example, gas discharged from the preheat zone via the flue gas outlet is typically ducted (hot, around 1100-1300° C.) to an afterburning chamber where there is final combustion of combustible gas in the flue gas and consequential heat generation.

The method may include discharging DRI from the discharge zone via the outlet into a vessel that is configured to restrict substantial ingress of oxygen-containing gases into the vessel. Positive nitrogen gas streams can be used to assist in this process.

Where the vessel is in part a container, that is exchanged on filling with a replacement container, it is preferred that such container remain sealed after filling. Without steps being taken to control the amount of oxygen available to the DRI, the oxygen can rapidly re-oxidise DRI, which then may become partially liquid.

One example of a vessel is a vessel that has (a) an opening to receive hot DRI, (b) forms an integral seal with the outlet of the furnace at least during filling the vessel, and (c) a closure that can close that opening after receiving the hot DRI. It is not necessary that the closure forms an absolutely gas-tight seal with the vessel, only that the closure be sufficient that it is sealed enough to restrict ingress of air that causes unacceptable levels of oxidation of DRI. The skilled person will understand the requirements for the gas-tight seal. Positive nitrogen gas streams can be used to limit access of air into the vessel.

The threshold bulk gas velocity for gases passing from the reduction zone to preheat zone may be any suitable velocity having regard to factors such as the material being processed and the size and shape and other structural characteristics of the hearth furnace.

There may be multiple gas pathways for gases passing from the reduction zone to preheat zone, but at least one pathway will reside above the height of the horn outlets. If there is a pathway through the microwave baffle in the transition zone the desirable threshold bulk gas velocity therefore is 5 m/sec or less.

For the avoidance of doubt, the overall gas velocity between the preheat zone and the reduction zone may be greater than 5 m/sec in embodiments where it is desirable to ensure that there is minimal inadvertent entrainment of gases from the preheat zone.

The invention also provides an apparatus for producing direct reduced iron (DRI), typically in a continuous manner, from iron ore and biomass, typically at least initially in the form of briquettes of a composite of iron ore fragments and biomass, the apparatus including a furnace that includes a chamber having:
(a) an inlet for iron ore and biomass, typically at least initially being in the form of briquettes of iron ore fragments and biomass, at one end and an outlet for DRI at the other end;
(b) a conveyor for receiving and transporting iron ore and biomass through a series of zones from the inlet to the outlet; and
(c) the following zones:
   (i) a feed zone that includes the inlet for iron ore and biomass,
   (ii) a preheat zone for heating iron ore and biomass and reducing iron ore and releasing volatiles in biomass and producing a preheated material, the preheat zone including a plurality of air or oxygen-enriched air fed burners for generating heat by burning combustible gases, typically in a top space, of the preheat zone, with the combustible gases including combustible gases originating within the furnace,
   (iii) a transition zone for compacting preheated material from the preheat zone on the conveyor and forming a compacted preheated material,
   (iv) a reduction zone for heating the compacted preheated material and reducing iron ore in material and forming DRI via microwave energy in the reduction zone; and
   (v) a discharge zone that includes the outlet for DRI.

The transition zone may comprise a microwave choke that is configured so that microwave energy is at least substantially prevented from passing from the reduction zone to the preheat zone.

The microwave choke may comprise an elongated metal section, such as a channel-shaped section, positioned in close proximity above and to the sides of the material on the conveyor.

The microwave choke may include a series of chambers, for example generally rectangular chambers, extending above and across a path of the conveyor as part of the elongated metal section residing in close proximity above and to the sides of the material on the conveyor. The series of chambers may be described as a ‘corrugated’ baffle.

The transition zone may include a driven roller, such as an internally-cooled driven roller, for contacting an upper surface of the material and compacting the material on the conveyor in the transition zone.

The roller may be configured for rotating at a rotational speed such that a velocity of an outer surface of the roller in the direction of movement of the conveyor is substantially the same as a velocity of the conveyor in the direction of movement of the conveyor.

The roller may be configured for applying a constant downward pressure on the material on the conveyor within a defined range of heights above the conveyor.

The roller may be located anywhere in the transition zone.

The roller may be located towards a preheat zone end of the transition zone.

The roller may be located sufficiently within the transition zone so that it is not substantially exposed to direct heating from combustion of combustible gases via air or oxygen-enriched air fed burners in the preheat zone.

The transition zone may include a plurality of driven rollers, such as internally-cooled driven rollers, along at least a part of a length of the transition zone for successinvely contacting an upper surface of the material and progressively compacting the material on the conveyor in the transition zone.

The reduction zone may include a plurality of microwave horns having microwave outlets for delivering microwave energy directly into the material on the conveyor as it moves through the reduction zone.

At least substantially all of the horns in each row may present in a co-polarisation (same orientation) manner to form a regular field pattern.

The horns may be arranged in a plurality of rows extending across a width of and along a section of a length of the reduction zone.

The microwave outlets may be spaced above but in close proximity to the material on the conveyor.

The rows of horns may be spaced apart along the length of the section of the length of the reduction zone so that there are gaps between the successive rows.

The horns in at least some of the rows may be spaced apart so that there are gaps between the horns.

There may be a microwave energy barrier in gaps between the horns that is configured to allow reduction gases to pass therethrough and to prevent microwave energy passing therethrough so that microwaves are substantially confined to a lower sub zone of the reduction zone.

The microwave energy barrier may include a perforated element, such as a perforated plate, that forms a skirt that fills gaps between the horns so that the interface is a continuous interface between the sub zones.

The horns of at least some of the rows may be offset laterally relative to the horns of at least some of the other rows—i.e. laterally relative to the direction of movement of briquettes through the reduction zone.

The horns of each row may be offset with respect to the horns of successive rows.

The horns may be pyramidal horns.

The pyramidal horns may include sectorial horns, each with one pair of opposing sides being flared and the other pair of opposing sides being parallel.

The sectoral horns in each row may be placed across the conveyor so that the shorter sides of rectangular openings of the sectoral horns are parallel with the direction of moment of the conveyor within the reduction zone.

In other embodiments, at least some of the sectoral horns in each row may be placed across the conveyor so that the longer sides of rectangular openings of the sectoral horns are parallel with the direction of moment of the conveyor within the reduction zone.

The reduction zone may include an upper subzone and a lower subzone and an interface separating the subzones that is configured so that (a) microwave energy is at least substantially prevented from passing through the interface to the upper sub zone, (b) reduction gases produced in the lower subzone from reduction of iron ore can flow through the interface into the upper subzone.

The horns may be arranged for heating material in the lower subzone.

The conveyor may be movable in an endless path, with the conveyor returning to the feed zone of the furnace from the discharge zone of the furnace.

The conveyor may have residual heat as a result of passing through the furnace when it returns to the feed zone of the furnace.

The apparatus may be configured to generate a higher pressure of gas in the reduction zone compared to gas pressure in the preheat zone to cause gases generated in the reduction zone to flow counter-current to the direction of movement of briquettes on the conveyor through the furnace.

The apparatus may include a gas flow “choke” between the preheat zone and the reduction zone that contributes to generating the higher gas pressure for causing gases in the reduction zone to flow counter-current to the direction of movement of briquettes on the conveyor through the furnace.

The gas flow “choke” may be configured to increase the flow rate of the gas from the reduction zone to the preheat zone by a factor of 2-3 compared to what the flow rate would be without the gas flow “choke” in order to ensure that there is no substantial gas flow from the reduction zone to the preheat zone of the furnace.

The gas flow “choke” may be the result of forming the transverse cross-sectional area of the reduction zone to be less than the transverse cross-sectional area of the preheat zone.

The apparatus may include a flue gas outlet in the preheat zone for discharging gas produced in the furnace that flows in the counter-current direction to the outlet.

The apparatus may include an afterburning chamber for combusting combustible gas in the gas discharged via the flue gas outlet.

### BRIEF DESCRIPTION OF THE DRAWINGS

The present invention is described further by way of example with reference to the accompanying drawings of a linear hearth, of which:

FIG. 1 is (a) a schematic diagram of one embodiment of an apparatus for producing direct reduced iron (DRI) from briquettes of a composite of iron ore fragments and biomass in accordance with the invention, (b) a temperature profile along the length of a furnace of the apparatus for an embodiment of a method for producing direct reduced iron (DRI) from briquettes of a composite of iron ore fragments and biomass in accordance the invention, and (c) a plot of off-gas volumetric flow rate of gas produced along the length of the furnace during the course of the method; and

FIG. 2 is a flowsheet diagram illustrating one embodiment of a method for producing direct reduced iron (DRI) from briquettes of a composite of iron ore fragments and biomass in accordance the invention in the apparatus of FIG. 1.

FIG. 3 is (a) a schematic diagram of a segment of a reduction zone of another, although not the only other, embodiment of the apparatus in accordance with the invention, showing two rows of horns, (b) is a theoretical static heating pattern showing the temperature profile of a bed of iron containing material passing under the horns shown in (a) as a result of heating via microwaves from the horns, and (c) is a theoretical dynamic heat pattern showing the temperature profile of the bed of iron containing material after having moved passed the two rows of horns.

FIG. 4(a) is a schematic diagram of part of the transition zone, showing a roller for compacting the preheated material on the conveyor and a microwave baffle that resides between the roller and the reduction zone; and

FIG. 4(b) is a schematic diagram of part of another embodiment of the transition zone similar to FIG. 4(a) that also shows a version where a scraper is applied to the roller.

### DESCRIPTION OF EMBODIMENTS

As noted above, in broad terms, the present invention is a method and an apparatus for continuously producing direct reduced iron (“DRI”) from iron ore and biomass, typically at least initially in the form of briquettes of a composite of iron ore fragments and biomass, that includes transporting iron ore and biomass through a furnace having an inlet for iron ore and biomass and an outlet for DRI and a feed zone, a preheat zone, a reduction zone and a discharge zone between the inlet and the outlet, and a transition zone between the preheat zone and the reduction zone, wherein there is a compacting device for compacting preheated material, typically by reducing the height of preheated material, as it passes thereunder.

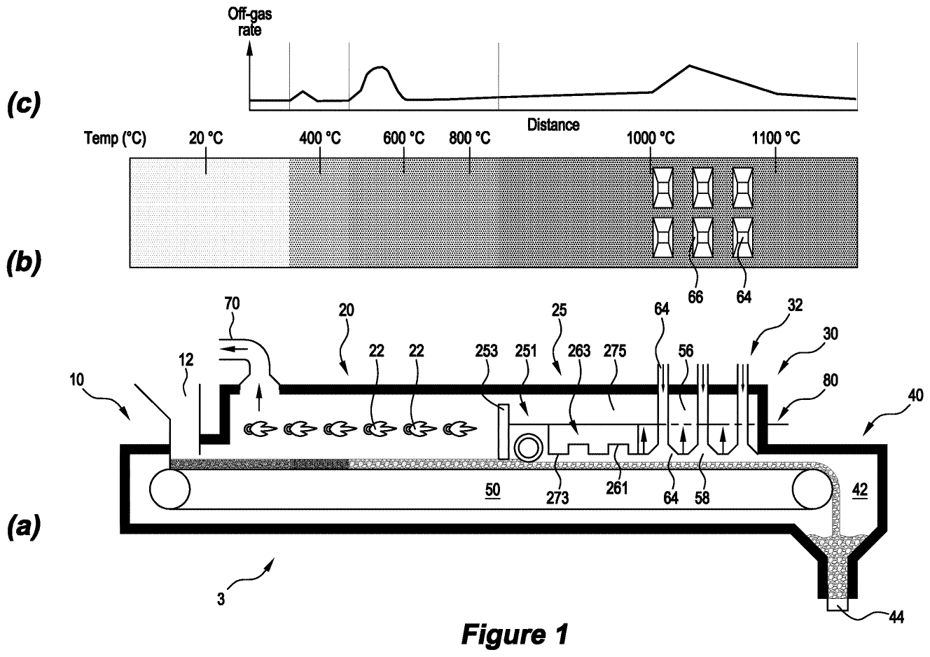

FIG. 1 is a schematic diagram of an embodiment of an apparatus of the present invention taken as a longitudinal section through a linear heath furnace.

As is described in more detail below, a key feature of the embodiments of the linear hearth furnace shown in the Figures is a transition zone between a preheat zone and a reduction zone, with the transition zone being configured for compacting iron ore/biomass material carried on the conveyor as it moves through the transition zone from the preheat zone to the reduction zone so that it presents a more homogenised as described herein bed of material as a result of compaction which is better suited to processing in the reduction zone.

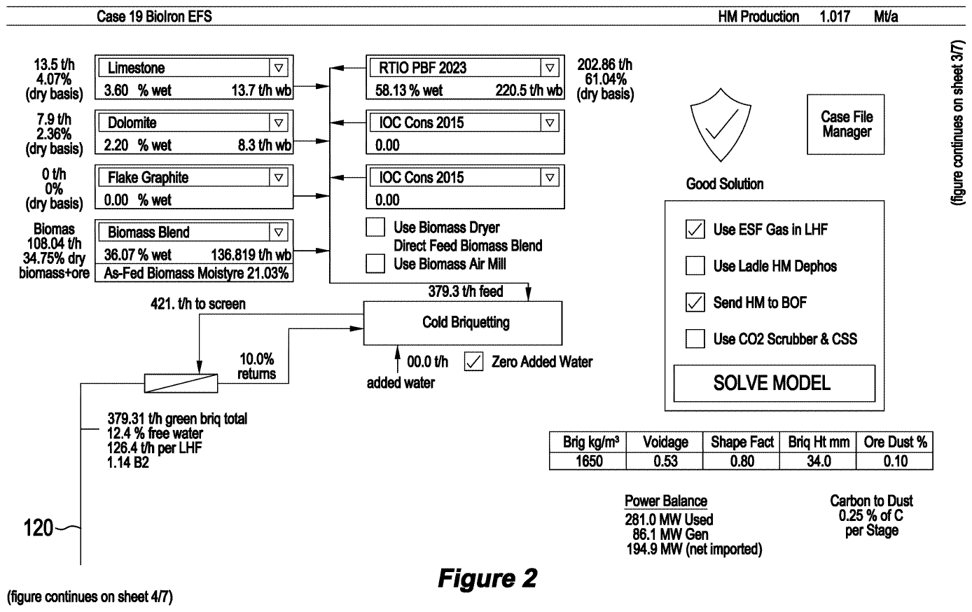

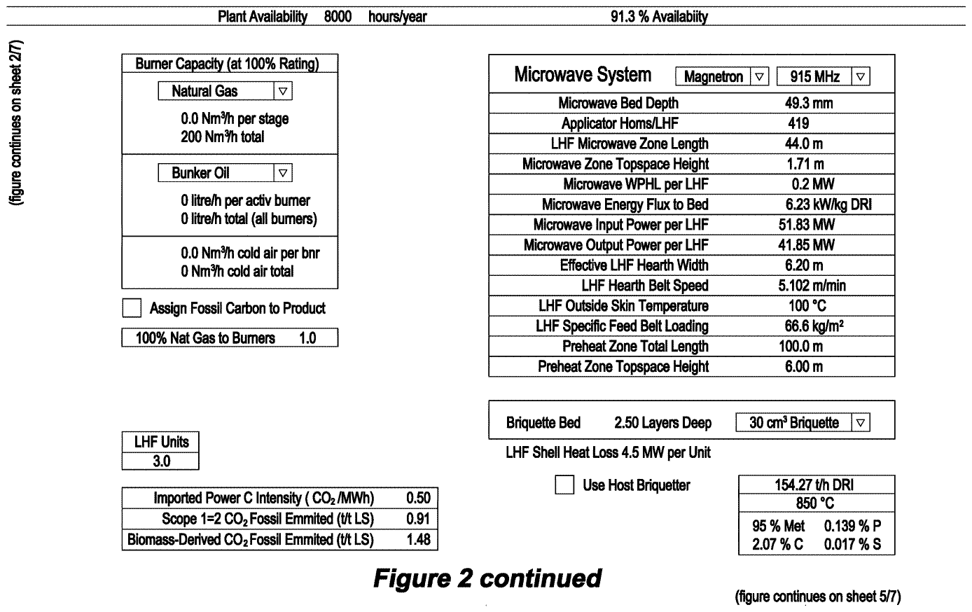

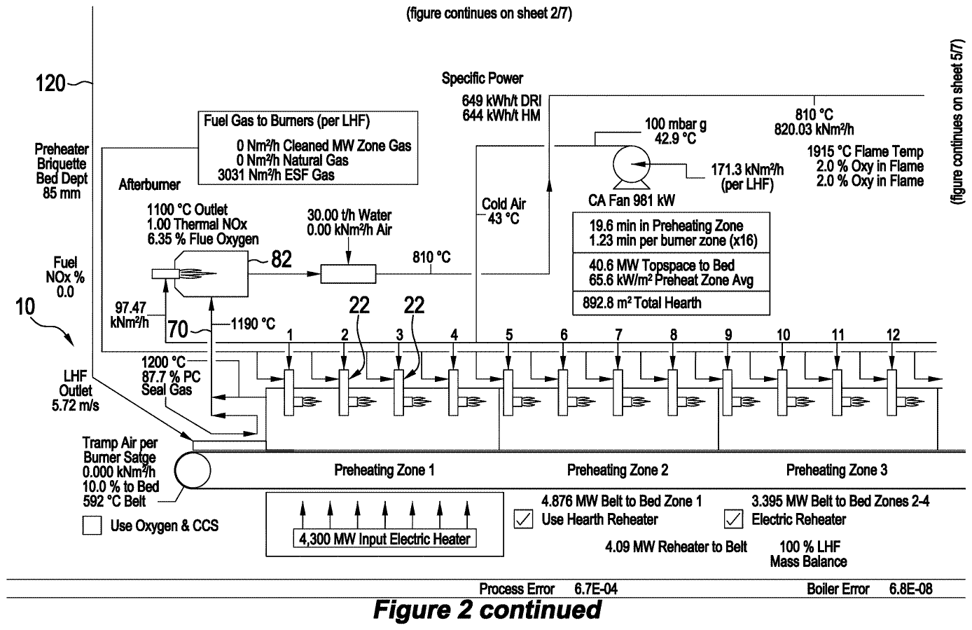

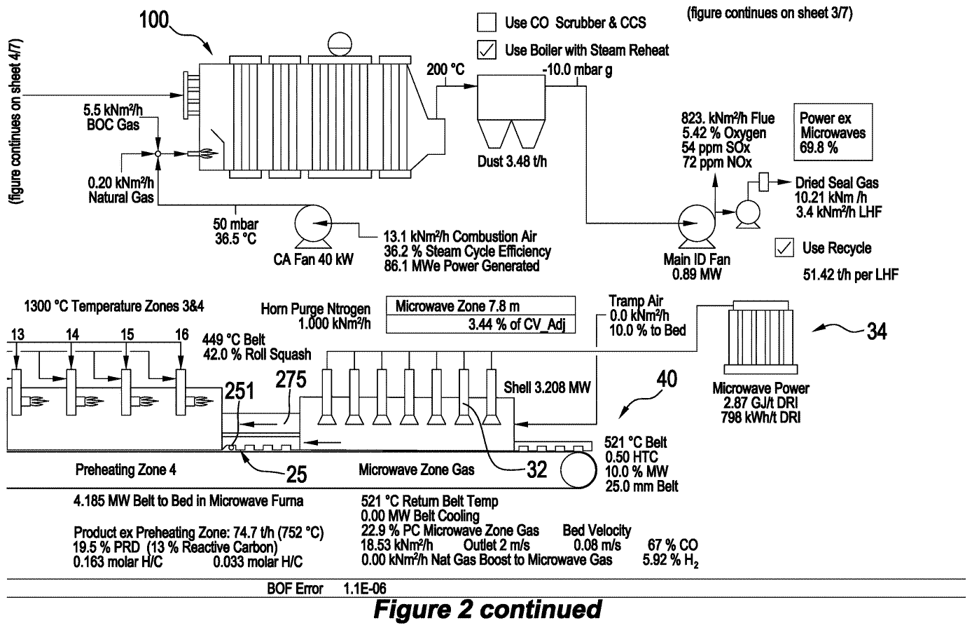

With reference to FIG. 1, the linear hearth furnace, generally identified by the numeral 3, includes an elongate refractory-lined chamber that has the following zones along its length:
(a) a feed zone 10 includes an inlet to the chamber and is configured to receive a feed material in the form of briquettes 120 (see FIG. 2) of iron ore and biomass, i.e. iron ore/briquette material,
(b) a preheat zone 20 for heating material, i.e. iron ore and biomass, in the briquettes and reducing iron ore and releasing volatiles in biomass and producing a preheated material, with the volatiles being combusted in the preheat zone,
(c) a reduction zone 30 for heating the preheated material further and reducing iron ore and forming DRI;
(d) a transition zone 25 between the preheat zone 20 and the reduction zone 30, with the transition zone 25 including a passageway 275 for gas flow from the reduction zone to the preheat zone 20 and a compacting device 251 for compacting the preheated material;
(e) a discharge zone 40 for DRI that includes an outlet of the chamber;
(f) an endless conveyor 50 having a refractory or metallic material base that moves through the chamber from the inlet to the outlet and transports material that is at least initially in the form of briquettes through the chamber from the inlet and discharges DRI from the outlet and then returns to the inlet to be re-loaded with additional briquettes; and
(g) a flue gas outlet 70 in the preheat zone 20 for discharging gas produced in the furnace by heating and/or combustion within the furnace.

The feed zone 10 is configured to continuously feed briquettes 120 into the feed zone 10 via the inlet to form a relatively uniform bed of briquettes on the moving conveyor 50 in the feed zone 10 of the chamber, while restricting outflow of furnace gases via the inlet. The feed zone 10 includes a feed chute 12 that can receive and direct briquettes 120 onto the conveyor 50. The term “relatively uniform bed of briquettes” is understood herein to mean a relatively uniform layer of briquettes covering the base and typically having a consistent ‘bed’ depth, at least length ways, i.e., in the direction of briquette travel within the furnace. This does not however mean that individual briquettes have to be stacked in anything more than a random way on the base, noting that in some embodiments this may be desirable.

The discharge zone 40 is configured to continuously discharge DRI from the discharge zone 40 via the outlet, while restricting the inflow of oxygen-containing gases into the reduction zone 30 of the chamber. The discharge zone 40 includes an enclosed discharge chute 42 that has a downwardly directed opening that has a flow control valve 44 that can be selectively operated to allow DRI to flow through the opening.

The preheat zone 20 has a plurality of air or oxygen-enriched air fed burners 22 (see FIG. 2) for generating heat by burning combustible gases in a top space of the preheat zone 20. The burners 22 are spaced along the length of the preheat zone 20. The optimal spacing can be readily determined by a skilled person for any given operating conditions, such as the amount and type of biomass and the amount and type of iron ore and the required metallisation.

The combustible gases generated in the furnace include combustible gases originating within the furnace. The combustible gases include:
(a) volatiles in biomass in material moving through the preheat zone 20; and
(b) combustible gases, such as CO, generated by reduction of iron ore in material in:
   (i) the preheat zone 20; and
   (ii) the reduction zone 30, with the combustible gases generated in the reduction zone 30 flowing from the reduction zone 30 to the preheat zone 20, as described further below.

There may be additional combustible gases supplied to the burners 22 depending on the operating conditions in the furnace.

In use, the reduction zone 30 is an anoxic environment.

The reduction zone 30 includes a plurality of microwave energy input units 32 (waveguides 64 and horns 66) in a top space thereof for heating briquettes. The microwave energy input units 32 are operatively connected to a microwave energy generator 34 (see FIG. 2—in which the generator is a microwave energy generator).

The horns 66 form an interface 80 (see the horizontal dotted line in FIG. 1) that separates the reduction zone 30 into an upper sub zone 56 and a lower sub zone 58.

The horns 66 are pyramidal horns, more particularly sectoral horns 66 in the embodiment shown in the Figures.

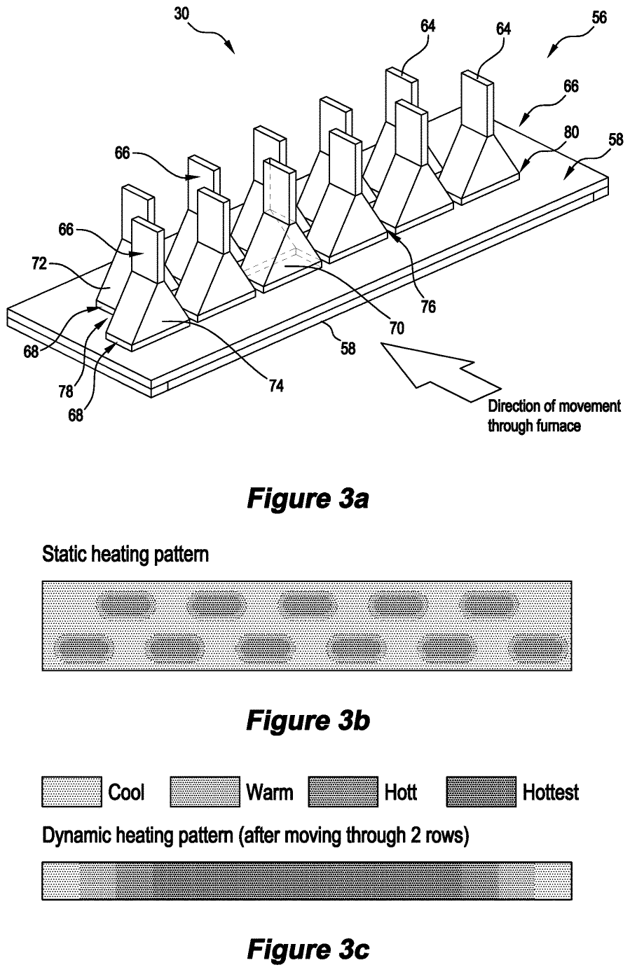

The horns 66 are arranged in rows 68 (see FIG. 3(a) which shows two rows only) having microwave outlets 70 for microwave energy. The rows 68 extend across a width of a section of the reduction zone 30 and along a length of the section above a top surface of the conveyor 50 and, in use above a top surface of material carried on the conveyor 50. The section may be any suitable length and any suitable width.

As can best be seen in FIG. 3(a), the horns 66 are in contact with each other at the microwave outlets 70 of the horns 66. Therefore, at this location, the interface 80 is a continuous interface, i.e. with no gaps between the horns 66 at this location.

The interface 80, as shown as a horizontal dotted line in FIG. 1, is a sharp transition between the upper sub zone 56 and the lower sub zone 58. It is noted that the invention is not confined to a sharp transition.

The horns 66 are defined by side walls 72, 74 that are typically formed from metal sheet material.

The horns 66 are rectangular in transverse section and are formed with only one pair of opposing side walls 72 being flared and diverging with distance from the waveguides 64 and the other pair of opposing sides 74 being parallel to each other which, in use, produces a fan-shaped beam, which is narrow in the plane of the flared side walls, but wide in the plane of the narrow side walls.

The flaring may be in the E-plane (electric field) or H-plane (magnetic field) direction to form a rectangular opening at its output end.

The horns 66 in each row are placed across the conveyor 50 so that the shorter sides of the rectangular microwave outlets 70 of the sectoral horns 66 are parallel with the direction of moment of the conveyor 50 within the reduction zone 30.

The horns 66 are arranged and configured so that the cumulative effect of the field patterns of the horns is to maximise the homogeneity of treatment of the material on the conveyor 50—see FIG. 3(c) where this is illustrated by the uniform temperature profile of material that have passed through the reduction zone 30.

The horns 66 within each row 68 are arranged in a co-polarisation (same orientation) manner to form a regular, typically highly uniform, field pattern, and with the horns in at least some of the rows 68 being offset laterally in relation to the horns of at least one of the other rows 68. FIG. 3(a) shows an embodiment of an off-set arrangement. This is not the only possible embodiment.

The side walls 72, 74 of the horns 66 may have a plurality of perforations (not shown), for example in the form of holes or slots, punched/cut through the side walls.

The perforations are configured to allow reduction gases from the lower sub zone 58 and to at least substantially prevent microwave energy from passing from the lower sub zone 58 into the upper sub zone 56.

The term ‘at least substantially prevent’ is a recognition that it is extremely difficult to prevent all microwave energy from passing from the lower sub zone 58 into the upper sub zone 56.

The arrangement and the size of the perforations will in part be determined by the wavelength of the microwave energy and the thickness and material of the side walls 72, 74 of the horns. The perforations may be of any size and/or shape but must be selected to prevent microwaves from passing through the perforations while not unduly restricting reaction gases passing therethrough.

As noted above, the transition zone 25 includes a passageway 275 for gas flow from the reduction zone 30 to the preheat zone 20 and a compacting device 251 for compacting the preheated material.

The compacting device 251 is in the form of a driven roller described further below.

The compacting device 251 is provided to compact material on the conveyor 50 as it moves through the transition zone 25 from the preheat zone 20 to the reduction zone 30 so that it presents a more homogenised bed of material which is better suited to processing with microwave energy in the reduction zone 30.

The compacting device 251 does this by applying a downward force onto material and thereby compacting by reducing the height of material passing through the gap between the compacting device 251 and the conveyor 50.

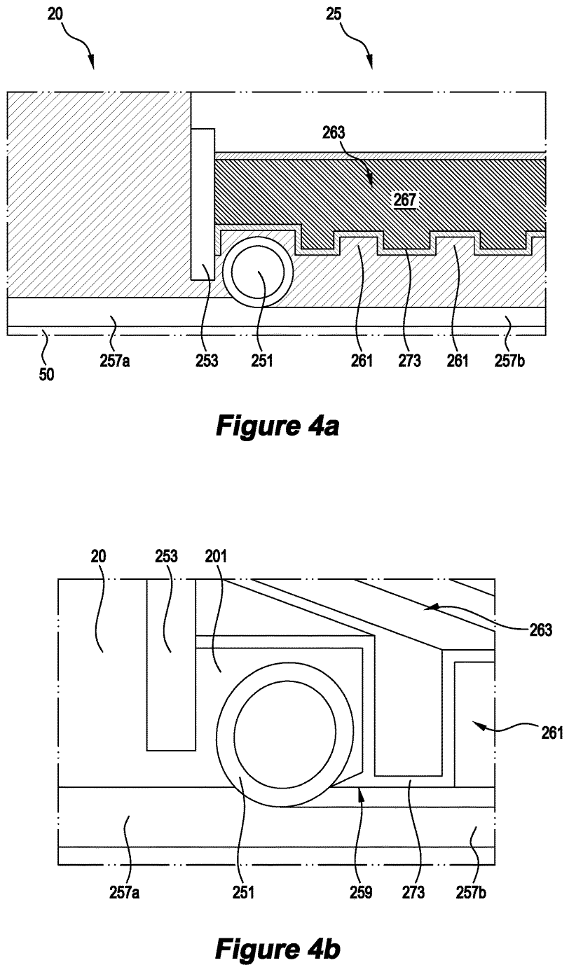

The transition zone 25 also includes a microwave choke, generally identified by the numeral 263 (FIGS. 4(a) and 4(b)) that contributes to at least substantially confining microwave energy within the transition zone 25 and at least substantially preventing microwave energy from passing from the reduction zone 30 to the preheat zone 20.

The microwave choke includes a microwave baffle (described further in FIGS. 4(a) and 4(b) that sits over the compacting device 251 and extends along the length of the transition zone 25 and is positioned so as to have a set maximum distance above the compacted bed of material on the conveyor 50. The microwave baffle is in the form of an elongated metal section with an upper wall and side walls. The microwave baffle is has a ‘corrugated’ upper wall that defines transverse chambers 261 across the width of the transition zone 25 and along the length of the transition zone 25.

A suspended refractory wall 253 sits in front of the compacting device 251. A gap between a lower end of the wall and the conveyor 50 defines a passage for material to pass therethrough prior to being compacted by the compacting device 251. It also forms a barrier over which upper end reaction gases that enter the upper sub zone 56 can pass from the reduction zone 30 to the preheat zone 20.

In use of the apparatus, gases generated in the reduction zone 30 flow into the preheat zone 20 counter-current to the direction of movement of briquettes on the conveyor 50 through the furnace from the inlet to the outlet.

The counter-current flow of gas from the reduction zone 30 into the preheat zone 20 is caused by a higher gas pressure in the reduction zone 30 compared to gas pressure in the preheat zone 20. While such pressure effect will be largely caused by the suction effect of a required exhaust fan linked to a dust extraction (baghouse) system at the atmosphere discharge end of the process the higher gas pressure is also the result of several structural and operational factors in the described embodiments of the method and the apparatus of the invention.

One factor is injecting nitrogen gas (or any other suitable gas) into the reduction zone 30 to contribute to generating and maintaining the higher pressure in the zone (and the anoxic environment).

Another factor is the volume of gas generated via reduction of iron ore in the reduction zone 30. This reduction gas contributes to generating and maintaining the higher pressure in the zone (and the anoxic environment).

The volume of reduction gas generated in the reduction zone 30 is illustrated by the plot of off-gas volumetric flow rate shown in FIG. 1.

A final factor is the induced draft fan at the end of the off-gas train (see FIG. 2); which depending on its size may have a significant influence.

The counter-current flow of gas from the reduction zone 30 to the preheat zone 20 transfers combustible gases, such as CO, that are generated in reactions that reduce iron ore in the reduction zone 30 to the preheat zone 20. The combustible gases in the gas flow from the reduction zone 30 are combusted by the plurality of air or oxygen-enriched air fed burners 22 spaced along the length of the preheat zone 20. The combustion profile may be 35-45% at a hot end of the preheat zone 20, i.e., at the end adjacent the reduction zone 30, increasing to 90-95% at a cold end of the preheat zone 20, i.e. at the end adjacent the feed zone 10.

The combustion of (a) combustible gases generated in the reduction zone 30, (b) combustion of volatiles released from biomass in the preheat zone, and (c) combustion of combustible gases generated by reduction of iron ore in the preheat zone 20 provides an important component of the heat requirements for the method.

The temperature profile shown in FIG. 1 is an example of a suitable temperature profile along the length of the furnace.

In use, the conveyor 50 transports material that is initially in the form of briquettes (not shown) of iron ore and biomass successively and continuously through the zones 10, 20, 25, 30, 40 in a sequential manner and eventually circles back in its endless path so that each portion of the refractory or metallic base material of the conveyor 50 eventually presents itself at the feed zone 10 to be loaded with more briquettes. Preferably, the refractory or metallic base material has residual heat from the chamber when the conveyor 50 returns to the feed zone 10.

In use, gases generated in the chamber are discharged as a flue gas via the flue gas outlet 70 in the preheat zone 20.

As described above in relation to the term “briquettes”, it is important for the invention that iron ore fragments and biomass be in quite close contact. Any approach to achieving this close contact may be used. Ore-biomass mixing followed by compaction of the materials to form briquettes between two rolls in which there are naturally aligning pockets, is one example. Alternative such compaction option is ore-biomass mixing followed by roll pressing using rolls without pockets into compressed slabs containing the iron ore fragments and biomass that break up naturally (or are deliberately broken up) prior to feeding into the feed station zone.

The briquettes may be manufactured by any suitable method. By way of example, measured amounts of iron ore fines and biomass and water (which may be at least partially present as moisture in the biomass) and optionally flux is charged into a suitable size mixing drum (not shown) and the drum rotated to form a homogeneous mixture. Thereafter, the mixture may be transferred to a suitable briquette-making apparatus (not shown) and cold-formed into briquettes.

In one embodiment of the invention, the briquettes are roughly 20 cm³ in volume and contain 30-40% biomass (e.g., elephant grass at 20% moisture). A small amount of flux material (such as limestone) may be included, with the balance comprising iron ore fines.

The physical structure of the DRI at the end of the process is not critical. The physical structure may be friable and break easily or it could resemble a robust 3D “chocolate bar”.

Either way, with further reference to FIG. 1, the DRI is fed into an insulated vessel (not shown) which is configured to transport the DRI (hot) to a downstream electric melting furnace (not shown). Here a feed system (not shown) can accept the hot DRI from the vessel and pass the DRI through a system of (for example) pushers and breaker bars (not shown) in order to feed the DRI into the electric melting furnace, including any furnace bath, for the production of steel.

It is noted that those structural components that are not specifically shown in FIG. 1 (excluding the componentry of the transition zone) are generally standard components within the iron industry and the skilled person would be able to make an appropriate selection of the components.

FIG. 2 is a process flowsheet diagram illustrating one embodiment of a method for producing direct reduced iron (DRI) according to the invention from cold-formed briquettes of iron ore and biomass in the furnace of FIG. 1.

The data in the diagram of FIG. 2 is derived from a model developed by the applicant and illustrates an embodiment of the method.

With further reference to FIG. 2, in the described embodiment based on a linear hearth furnace arrangement as shown in FIG. 1, cold-formed briquettes are continuously feed onto a conveyor travelling at around 5 m/min. that has a refractory or metallic base that presents to the briquettes through a feeding device (not shown) to create a bed depth of around 60 mm and to deliver around 80 tonnes per hour of briquettes into the furnace. The effective width of the base for receiving briquettes is four (4) metres.

The briquettes comprise 37% elephant grass at 20% water, 5% limestone and 58% Pilbara Blend iron ore fines.

The length of the preheat zone 20 is 140 metres and is divided into 4 sections for ease of processing controls.

The length of the reduction zone 30 is 60 metres with 50 microwave energy input units 32 extending downwardly into the top space thereof.

A gas flow restriction may be created between the two zones through the use of a baffle wall that changes the top space heights between the two zones, with the top space height and the overall transverse cross-sectional area of the reduction zone 30 being less than that of the preheat zone 20.

In creating a transition zone with the features as shown in FIG. 4 there will additionally be at least an opening through the baffle wall above the outlets of the hoods.

In the FIG. 2 embodiment, gas flowing from the reduction zone 30 to the preheat zone 20 has been combusted to a post combustion degree of around 10-30% in the reduction zone, depending on the amount of ingress air into the reduction zone 30, such as from the discharge zone 40. Therefore, there is considerable combustible gas in this gas.

In the FIG. 2 embodiment, the amount of gas flowing from the reduction zone 30 to the preheat zone 20 is around 200-300 Nm³/tonne of DRI discharged from the furnace, and the gas velocity at the interface between the reduction zone 30 and the preheat zone 20 is around 4-10 m/s (nominally 5 m/s).

As described in relation to FIG. 1, the gas flows into and along the preheat zone 20, counter-current to the movement of briquettes, and the gas is subjected to incremental combustion as it passes through the plurality of air or oxygen-enriched air fed burners 22 which, in this embodiment, receive preheated (and/or oxy-enriched) air.

The post-combustion profile in the preheat zone 20 is typically 35-45% at the hot end (i.e., the reduction zone 30 end), increasing gradually to around 90-95% at the flue gas outlet 70 end. The preheat zone top space is therefore maintained in a bulk reducing condition all the way along its length in the embodiment, with feed oxygen being consumed rapidly in the vicinity of each burner 22 (in a small localised region).

Off-gas at the flue gas outlet 70 end is then ducted (hot, around 1100-1300° C.) to an afterburning chamber 82, where final combustion of combustible gas in the gas is performed.

The gas from the afterburning chamber 82 is then used (in the example provided) to preheat air for the burners 22 in the preheat zone 20 via a heat exchanger 90, before passing to a boiler 100 for final heat recovery and then discharge as flue gases to the atmosphere.

This example necessarily contains multiple assumptions regarding kinetic parameters-precise details may shift as a result of different kinetics. However, the principles are not expected to change. Although the current example is based on preheated air, additional oxygen could be added to the air mixture prior to heating so that the ratio of air to oxygen could be varied as an additional control parameter to further optimise the process.

FIG. 3(a) is a schematic of the inside of a segment of the reduction zone 30 of a linear hearth furnace of one embodiment of an apparatus in accordance with the invention.

FIG. 3(a) shows two rows 68 of off-set sectoral horns 66, each row placed above and extending across a top surface of a conveyor 50 so that the shorter sides 72 of the microwave outlets 70 of the horns are parallel with and the longer sides 74 of the microwave outlets 70 are perpendicular to the direction of moment of the conveyor within the linear hearth furnace.

FIG. 3(a) also shows an interface 80 that separates the reduction zone 30 into an upper sub zone 56 and a lower sub zone 58. There are small gaps 76 between the horns 66 in each row 68 and there is a small gap 78 between the rows 68 at the level of the microwave outlets 70.

Whilst not shown in the Figure, these small gaps 76, 78 are closed by a microwave energy barrier that is configured to allow reduction gases to pass therethrough and to at least substantially prevent microwave energy passing therethrough.

The microwave energy barrier may be in the form of perforated metal elements that are connected to the horns 66 close to the microwave outlets 70. The end result is that the interface 80 comprises the horns 66 and the microwave energy barrier in the gaps, and the interface 80 is a single continuous interface at this height of the reduction zone 30.

FIG. 3(b) is the theoretical temperature profile of a bed of iron containing material that receives microwaves under such a horn structure (i.e., as a static heating pattern without the conveyor moving).

FIG. 3(c) is the theoretical temperature profile of the same bed of iron containing material having moved on the conveyor past the two rows of horns.

FIGS. 4(a) and 4(b) provide more details of the transition zone 25.

FIG. 4(a) is a schematic diagram of the lower part of the transition zone 25 (there is a passageway 275 for reaction gases (not shown) that sits above this apparatus, but is shown in FIGS. 1 and 2).

The Figure shows the above-mentioned compacting device 251, in the form of an internally cooled (hollow) roller 251, for compacting the preheated material on the conveyor 50 located close to the preheat zone end of the transition zone 25.

The roller 251 is preferably configured to be driven in an anticlockwise direction so that the rotational speed of the internally cooled driven roller is such that a velocity of an outer surface of the roller 251 in the direction of movement of the conveyor 50 is substantially the same as a velocity of the conveyor in the direction of movement of the conveyor. However, it is noted that the velocity may be varied to suit operational circumstances.

The roller 251 is configured to apply a constant downward pressure approach (apparatus for such not shown) within a defined range of heights above the conveyor 50. Such constant downward pressure can be achieved for example by the use of springs. It is noted that the pressure may be variable in other embodiments.

While a hollow roller 251 is shown, it may be necessary (for spanning across the furnace purposes) in some embodiments to have a shaft-supported roller set up, where for example an outer sleeve is made of copper and there are series of channels between that sleeve and the main body of the shaft of the roller, which may be made of steel.

It can be seen from the Figure that the internally cooled driven roller 251 is located sufficiently within the transition zone 25 behind the suspended refractory wall 253 such that it is not likely to be substantially exposed to direct radiation arising from the combusting of combustible gases via air or oxygen-enriched air fed burners in the preheat zone.

The internal cooling of the roller 251, may take many forms. It may for example be forced gas cooled or have a fluid coolant, with a high boiling point.

FIG. 4(a) also shows a part of the above-mentioned microwave choke 263, that is located between the roller 50 and the reduction zone 20.

The microwave choke 263 comprises a hollow cooling chamber 267. The microwave choke 263 also includes a microwave baffle. The microwave baffle is in the form of an elongated metal section with an upper wall 273 and side walls extending downwardly from opposite side edges of the upper wall 273. The upper wall 273 forms a part of a wall of the cooling chamber 267. The cooling chamber 267 keeps the upper wall 273 cools. The upper wall 273 has a corrugations that define transverse chambers 261 across the width of the transition zone 25 and along the length of the transition zone 25.

FIG. 4(b) is also a schematic diagram of the lower part of another embodiment of the transition zone 25 that is similar to the transition zone 25 of FIG. 4(a) and showing an internally cooled (hollow) roller 251 for compacting the preheated material on the conveyor and a microwave choke 263 that is located between the roller 251 and the reduction zone 30, with the addition of a scraper 259 to remove any loose or easily removed material built up on or carried over on the surface of the roller 251. The scraper 259 may be as a solid unit, the edge of which contacts the roller 251 or multiple bristles in the form of a wire brush. In either case, besides removing material from the roller 251, the scraper 259 can form a barrier to the flow of gases through the transition zone, by prevent gases from flowing over the roller 251 in the cavity in the lower part of the transition zone provided for such roller.

Many modifications may be made to the embodiments described above without departing from the spirit and scope of the invention.

Bt way of example, whilst the embodiment shown in FIG. 1 includes a single compacting device 251 (in the form of a driven roller in FIG. 1) in the transition zone 25, it can readily be appreciated the invention is not confined to a single compacting device 251. For example, there may be several successive compacting devices 251. These compacting devices 251 may be driven rollers at successive lower heights in relation to a top surface of the conveyor 50.

By way of further example, the invention is not confined to the embodiment of the compacting device 251 shown in FIGS. 4a and 4b. The invention extends to any suitable driven roller and other type of compacting device.

By way of further example, whilst the embodiment shown in FIG. 2 includes an 80 tonnes per hour briquette fed furnace that is 4 m wide by 200 m long (with a bed depth of 60 mm), with the briquettes comprising 38% elephant grass at 20% water, 5% limestone and 57% Pilbara Blend iron ore fines, it can readily be appreciated the invention is not confined to this size briquette bed with this composition of the briquettes.

By way of further example, whilst the conveyor 50 in the embodiment shown in FIG. 2 has a refractory or metallic material base, the invention is not limited to this arrangement and extends to any suitable conveyor.

By way of further example, whilst the embodiment shown in FIG. 2 includes the use of nitrogen gas injection to generate and maintain the anoxic environment in the reduction zone, the invention is not limited to this particular gas.

In addition, the invention is not confined to such gas injection at all if the gas generated via reduction of iron ore in the reduction zone 30 is sufficient to maintain the required anoxic environment.

By way of further example, whilst the above embodiment includes continuous operation, the invention is not so limited.

By way of further example, whilst the embodiments shown in the Figures include feed material in the form of briquettes of iron ore and biomass, the invention is not so limited and extends to other forms of the material. For example, the material may be a bed of iron ore and biomass.

### REFERENCES

1. Vogl, V et al, Assessment of hydrogen direct reduction for fossil-free steelmaking, Journal of Cleaner production 203 (218) 736-745
2. Strezov, V, Iron ore reduction using sawdust: experimental analysis and kinetic modelling, renewable Energy 31(12) 1892-1905, October 2006

1. A method for producing direct reduced iron (DRI) from iron ore using biomass as a main source of reductant in a hearth furnace having a preheat zone, a transition zone, and a reduction zone, the method including moving a conveyor carrying an iron ore/biomass material successively through the preheat zone, the transition zone, and the reduction zone in a direction from an inlet to an outlet and heating and reducing iron ore and discharging DRI from the outlet, allowing reduction gases including combustible gases produced by heating material and by reduction of iron ore to flow in an opposite direction to the direction of movement of the conveyor, i.e. towards the preheat zone, combusting combustible gases in the reduction gases via air or oxygen-enriched air fed burners in the preheat zone, while maintaining an anoxic atmosphere in the reduction zone and supplying microwave energy therein to facilitate reduction of iron in the reduction zone, and compacting material carried on the conveyor and forming a compacted bed of the material as the material moves through the transition zone and before material reaches the reduction zone.

2. The method defined in claim 1 includes compacting the material on the conveyor by a roller or a series of successive rollers contacting an upper surface of the material in the transition zone.

3. The method defined in claim 2 includes selecting a rotational speed of the roller such that a velocity of an outer surface of the roller in the direction of movement of the conveyor is substantially the same as a velocity of the conveyor in the direction of movement of the conveyor.

4. The method defined in claim 2 includes compacting material so that a cross-sectional area of the material is reduced by reducing a height thereof.

5. The method defined in claim 2 includes applying a constant downward pressure on the material via the roller.

6. The method defined in claim 1 includes supplying briquettes of the material at ambient temperature to the preheat zone and progressively heating briquettes to a finish preheat temperature as briquettes are transported through the preheat zone.

7. The method defined in claim 1 includes controlling the method so that at least 90% of volatiles in biomass in the material are released as a gas in the preheat zone.

8. The method defined in claim 1 includes generating a higher pressure of gases in the reduction zone compared to gas pressure in the preheat zone and thereby causing gases generated in the reduction zone to flow counter-current to the direction of movement of the material on the conveyor through the furnace.

9. An apparatus for producing direct reduced iron (DRI) from iron ore and biomass, the apparatus including:
(a) a furnace that includes a chamber having an inlet for iron ore and biomass at one end and an outlet for DRI at the other end,
(b) a conveyor for receiving and transporting iron ore and biomass from the inlet to the outlet, and
(c) the following zones:
(i) a feed zone that includes the inlet for iron ore and biomass,
(ii) a preheat zone for heating iron ore and biomass and reducing iron ore and releasing volatiles in biomass and producing a preheated material, the preheat zone including a plurality of air or oxygen-enriched air fed burners for generating heat by burning combustible gases in the preheat zone, with the combustible gases including combustible gases originating within the furnace,
(iii) a transition zone for compacting preheated material from the preheat zone on the conveyor and forming a compacted preheated material,
(iv) a reduction zone for heating the compacted preheated material and reducing iron ore and forming DRI via microwave energy in the reduction zone; and
(v) a discharge zone that includes the outlet for DRI.

10. The apparatus defined in claim 9 wherein the transition zone includes a microwave choke that is configured so that microwave energy is at least substantially prevented from passing from the reduction zone to the preheat zone.

11. The apparatus defined in claim 10 wherein the microwave choke includes an elongated metal section, such as a channel-shaped section, positioned in close proximity above and to the sides of the material on the conveyor.

12. The apparatus defined in claim 11 wherein the microwave choke includes a series of chambers, for example generally rectangular chambers, extending above and across a path of the conveyor as part of the elongated metal section residing in close proximity above and to the sides of the preheated material on the conveyor.

13. The apparatus defined in wherein the transition zone includes a driven roller for contacting an upper surface of the preheated material and compacting the material on the conveyor in the transition zone.

14. The apparatus defined in claim 13 wherein the roller is configured for rotating at a rotational speed such that a velocity of an outer surface of the roller in the direction of movement of the conveyor is substantially the same as a velocity of the conveyor in the direction of movement of the conveyor.

15. The apparatus defined in claim 13 wherein the roller is configured for applying a constant downward pressure on the material on the conveyor within a defined range of heights above the conveyor.

16. The apparatus defined in claim 13 wherein the roller is located towards a preheat zone end of the transition zone.

17. The apparatus defined in claim 9 wherein the reduction zone includes a plurality of microwave horns having microwave outlets for delivering microwave energy directly into the material on the conveyor as it moves through the reduction zone.

18. The apparatus defined in claim 17 wherein the microwave horns are in a plurality of rows extending across a width of and along a section of a length of the reduction zone.

19. The apparatus defined in claim 18 wherein the rows of horns are spaced apart along the length of the section of the length of the reduction zone so that there are gaps between the successive rows.

20. A method and apparatus for producing direct reduced iron (DRI) from iron ore using biomass as a main source of reductant in a hearth furnace having a preheat zone, a reduction zone, and a transition zone between the preheat and the reduction zones, with the transition zone being configured for compacting an iron ore/biomass material carried on a conveyor as it moves through the transition zone from the preheat zone to the reduction zone so that it presents a compacted bed of material which is suited to processing with microwave energy in the reduction zone.
